(19) United States
(12) Patent Application Publication
(10) Pub. No.: US 2020/0118056 A1
(43) Pub. Date: Apr. 16, 2020

(54) METHOD AND SYSTEM OF PROCESSING DATA

(71) Applicant: Swipejobs, Inc., Austin, TX (US)

(72) Inventor: Katrina Lee-Anne Leslie, Mosman (AU)

(21) Appl. No.: 16/598,348

(22) Filed: Oct. 10, 2019

Related U.S. Application Data
(60) Provisional application No. 62/744,942, filed on Oct. 12, 2018.
(60) Provisional application No. 62/767,063, filed on Nov. 14, 2018.
(60) Provisional application No. 62/791,416, filed on Jan. 11, 2019.

(51) Int. Cl. G06Q 10/06

(52) U.S. Cl. CPC G06Q 10/063112; G06Q 10/06315; G06Q 10/06314; G06Q 10/063116

(57) ABSTRACT

A data processing server can be accessible by customers and providers to process a transaction. The data processing server can provide an application programming interface that is accessible via a computing device of the customers and providers. The data processing server can be capable of receiving an order, matching the order with profiles of candidates/workers, and providing the results of the matching to the customers and/or matched candidates/workers. In particular, the order matching can be performed using a more accurate complex multi-dimensional matching method. Further, the data processing server can perform the matching against the profiles of candidates/workers of a plurality of staffing firms or other talent pool providers.

### RELATED APPLICATIONS

This application claims the benefit of U.S. Provisional Application No. 62/744,942 filed Oct. 12, 2018, U.S. Provisional Application No. 62/767,063 filed Nov. 14, 2018, and U.S. Provisional Application No. 62/791,416 filed Jan. 11, 2019, each of which is hereby fully incorporated herein by reference.

### TECHNICAL FIELD

The present invention relates generally to data processing and, in particular, to processing on-demand jobs so that the jobs are matched with the appropriate workers. An embodiment of the present invention relates to deriving parameters relating to a worker of a user profile and extending the user profile based on the derived parameters. An embodiment of the present invention also relates to deriving requirements relating to an order. Another embodiment of the present invention relates to automated matching between a worker and an on-demand job.

### BACKGROUND

Presently, a staffing firm has its own database that includes workers or candidates for fulfilling an order for a job placement. The database of each staffing firm is not connected to databases of other staffing firms. Therefore, a candidate/worker of a staffing firm only has access to orders placed with that staffing firm.

When a candidate/worker registers with a staffing firm, the candidate/worker is typically requested to submit their details, such as name, location, skills, experience, credentials, and the like. The candidate/worker may also be requested to submit their job preferences (e.g., job location, pay rate, etc.). However, such details and preferences may not be accurate. For example, a candidate/worker may submit that one of their job preferences include any jobs that are within 10 miles of the worker's location in order to receive as many job invitations as possible. However, the candidate/worker intends to only travel 5 miles for any jobs.

In another example, the candidate/worker may submit that he has skills in commercial cleaning even though his skills are domestic cleaning. In this example, the candidate/worker may accept commercial cleaning jobs but continually not performed well due to his lack of skills. When employers provide feedback that the worker's cleaning skills are not sufficient, the worker may cease receiving commercial cleaning job placements with those employers but continue to receive commercial cleaning job placements with other employers.

Further, the details and preferences of a candidate/worker change over time. Currently, conventional arrangements are not capable of determining, deriving, and learning inaccurate details and/or preferences of a candidate/worker profile. Conventional arrangements are also not capable of extending the candidate/worker profile based on the candidate/worker behaviours or feedback received from employers.

Therefore, candidates/workers information on factors required by the employer for the job, for example, skills, experience, credentials, and education are typically not complete or up-to-date for the majority of candidates/workers in staffing firm databases. Another reason is because there is no motivation or practical way for the candidate/worker to add or update these factors.

Further, for conventional arrangements, it is difficult to understand previous performance of a worker on similar jobs due to lack of recorded ratings and the complexity of judging these performances across different skills and jobs. Further, a worker's job preferences are not systematically collected and used in the matching process by recruiters. It is also difficult for conventional arrangements to collect information on performance of workers, let alone updated information of workers. Conventional arrangements typically do not collect such information because it is difficult to do so. One problem is because collecting performance information manually is difficult and time consuming, especially in a time pressure delivery model. It is also difficult to train recruiters to collect information reliably so that the performance information can be used consistently in matching workers with job orders.

The above problems lead to regular matching of unsuitable candidates/workers with jobs.

The above problems are compounded when the job matching process is performed manually by a recruiter. A recruiter of the staffing firm fulfils the order manually by running filters on the candidates/workers profile in the database based on the requirements (e.g., skills, experience, location, etc.) of the job order. The recruiter then reviews the filtered candidates/workers to determine which candidates/workers could fulfil the order. Usually, a recruiter places the people they are most familiar with or they know will probably be available. The recruiter also does not conduct a comprehensive matching process on all candidates and workers in the database, as such is not possible to be performed on conventional arrangements as such candidate/worker profiles are inaccurate and lack details.

Even further, it is difficult for conventional arrangements to find best matched candidates (based on skills and previous performance) in a large and diverse pool in a timely fashion.

Therefore, in view of the above problems, the process of filtering and manually determining which candidates/workers could fulfil the order possibly result in the order not being filled, the candidates being placed on the job not being the best worker available, or better candidates/workers missing out on the job due to inaccurate filters being used.

Another problem also exists that multiple staffing firms are required by a worker to understand the job choices available on the market.

Further, conventional arrangements cannot provide real-time matching of job order with workers as conventional arrangements do not have up-to-date information (e.g., factors required by an employer, etc.).

### SUMMARY

It is an object of the present invention to substantially overcome, or at least ameliorate, one or more disadvantages of existing arrangements.

Disclosed are arrangements which seek to address the above problems by providing a data processing server that is accessible by customers and providers to process a transaction. The data processing server provides an application programming interface (API) that is accessible via a computing device (e.g., a mobile phone) of the customers and providers (e.g., staffing firms, workers, candidates). The data processing server is capable of receiving an order, matching the order with profiles of candidates/workers, and providing the results of the matching to the customers and/or matched candidates/workers. In particular, the order matching is performed using a more accurate matching process using a complex multi-dimensional matching method. Further, the data processing server performs the matching against the profiles of candidates/workers of a plurality of staffing firms or other talent pool providers.

Disclosed are also arrangements to determine actions of candidates/workers or feedback from employers. Worker-related parameters can then be derived from the determined actions or input. These worker-related parameters can then be used to extend the candidate/worker profiles. Therefore, the disclosed arrangements enable a candidate/worker profile that is incomplete or inaccurate to be extended and enhanced based on the actions of the candidate/worker associated with the profile or the feedback provided by employers. The extended/enhanced profile can also be called as a learned profile.

As discussed above in the Background section, a candidate/worker may provide details and preferences that are recorded in the candidate/worker profile. Typically, this kind of profile does not have much detail and can be considered to only provide 5% of relevant information regarding the candidate/worker. The disclosed arrangements enable such profile to be enhanced and extended such that the enhanced/extended profile provides 300% more information in comparison to the original (i.e., unenhanced) profile.

According to a first aspect of the present disclosure, there is provided a method of extending a profile, the method comprising: determining actions of a user associated with the profile; deriving parameters of the user based on the determined actions; and extending the profile based on the derived parameters.

According to another aspect of the present disclosure, there is provided a system comprising: a processor; memory in communication with the processor, wherein the memory comprises computer application programs that are executable by the processor to perform a method of extending a profile, the method comprising: determining actions of a user associated with the profile; deriving parameters of the user based on the determined actions; and extending the profile based on the derived parameters.

According to another aspect of the present disclosure, there is provided a non-transitory computer readable medium comprising: computer application programs that are executable by a processor, the computer application programs comprising a method of extending a profile, wherein the processor executes the computer application programs to perform the method, the method comprising: determining actions of a user associated with the profile; deriving parameters of the user based on the determined actions; and extending the profile based on the derived parameters.

According to a further aspect of the present disclosure, the method further comprising: determining input of a second user on the user associated with the profile; deriving parameters of the user based on the determined input; and extending the profile based on the parameters derived based on the determined input.

According to another aspect of the present disclosure, there is provided a computer program product including a computer readable medium having recorded thereon a computer program for implementing any one of the methods described above.

Other aspects are also disclosed.

### BRIEF DESCRIPTION OF THE DRAWINGS

At least one embodiment of the present invention will now be described with reference to the drawings and appendices, in which:

FIG. 1 shows a system for processing data in accordance with an aspect of the present disclosure;

FIGS. 2A and 2B form a schematic block diagram of a general purpose computer system upon which the data processing server of FIG. 1 can be practiced;

FIG. 3 is a schematic block diagram of services provided by the data processing server of FIG. 1;

FIG. 4 is a flow diagram of a method of managing candidate/worker profiles in the data processing server of FIG. 1;

FIG. 5 is a flow diagram of a method of processing a transaction in the data processing server of FIG. 1;

FIG. 6 is a flow diagram of a method of matching an order with available workers in the data processing server of FIG. 1;

FIG. 7 is a flow diagram of a method of creating a new order based on a real time market depth of the order; and

FIG. 8 is a flow diagram of a subprocess of determining the real time market depth of the order of FIG. 7.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section relate to discussions of processes which form public knowledge through their respective publication and/or use. Such should not be interpreted as a representation by the present inventor(s) or the patent applicant that such processes in any way form part of the common general knowledge in the art.

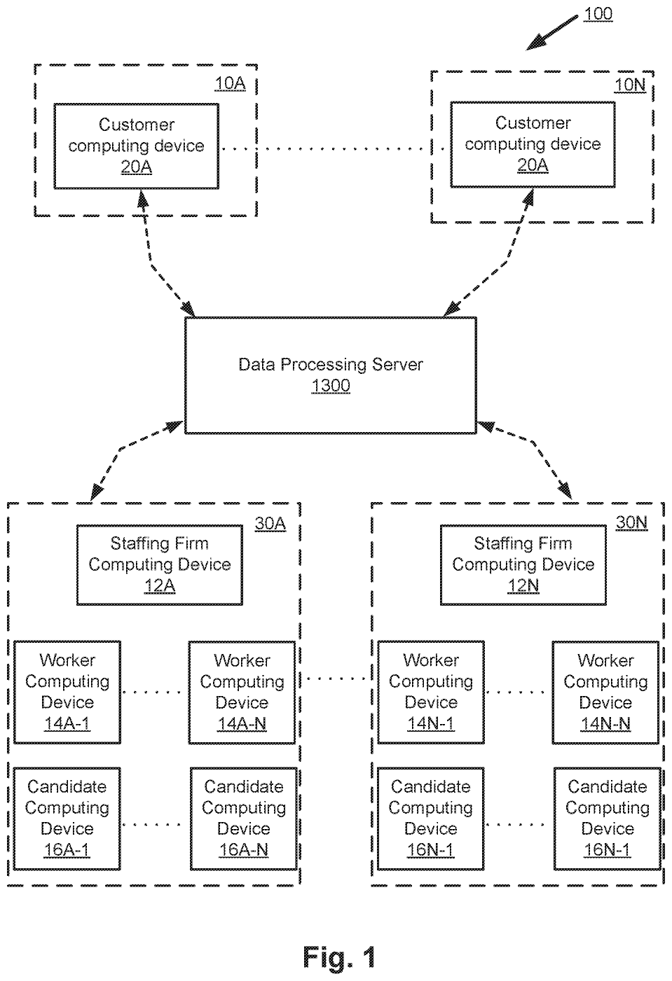

FIG. 1 shows a system 100 comprising a data processing server 200, customer computing devices 20A to 20N, staffing firm computing devices 12A to 12N, worker computing devices 14A-1 to 14A-N, 14N-1 to 14N-N, and candidate computing devices 16A-1 to 16A-N, 16N-1 to 16N-N.

Hereinafter, the system 100 is described in relation to processing a transaction relating to job placements. However, as a skilled person would understand, the system 100 can be implemented for other purposes such as a transaction relating to product sales.

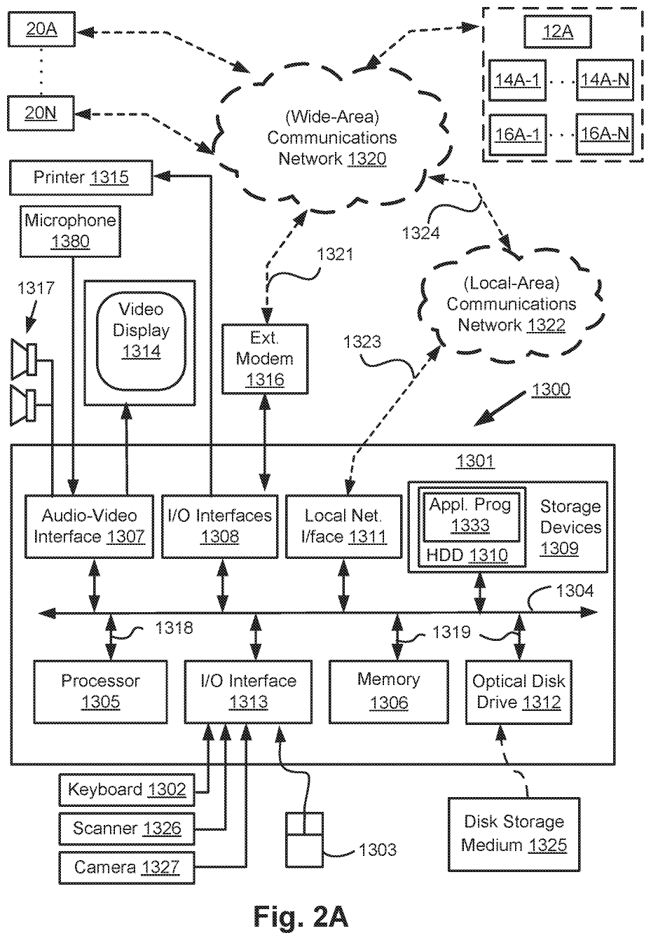

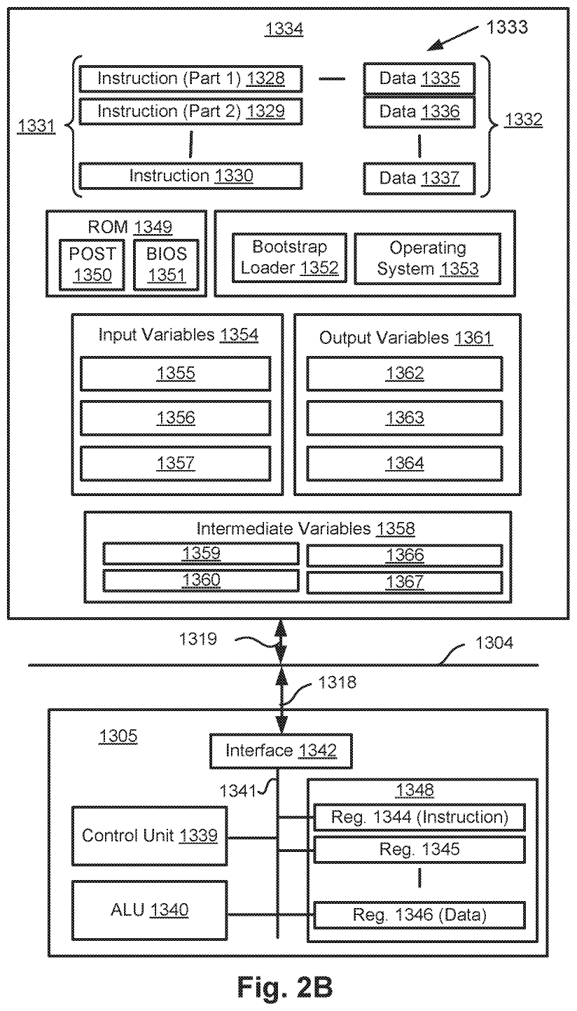

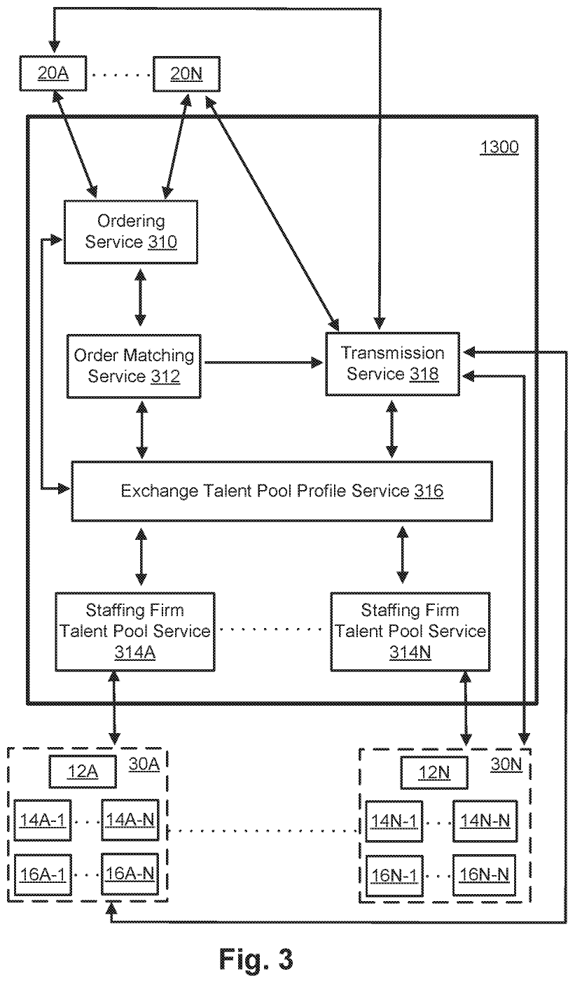

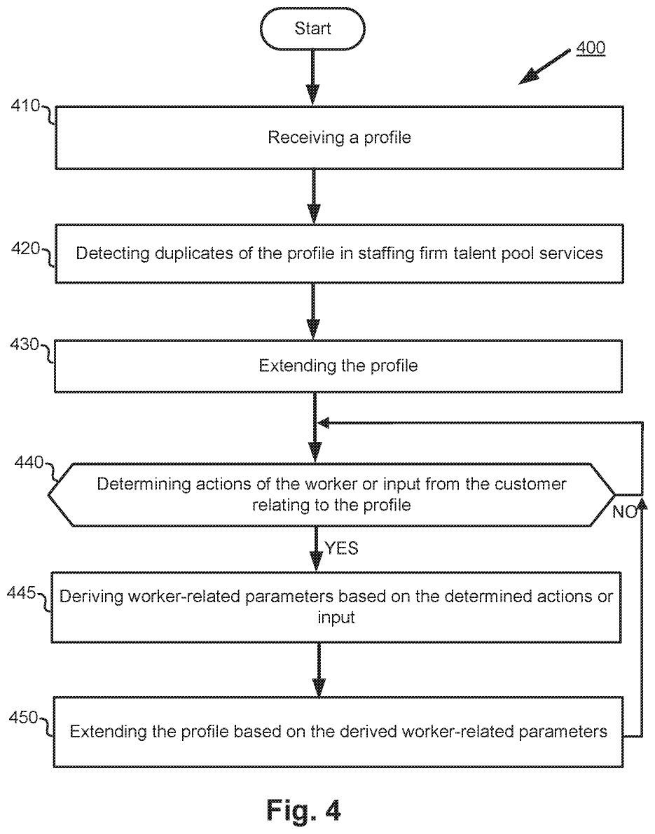

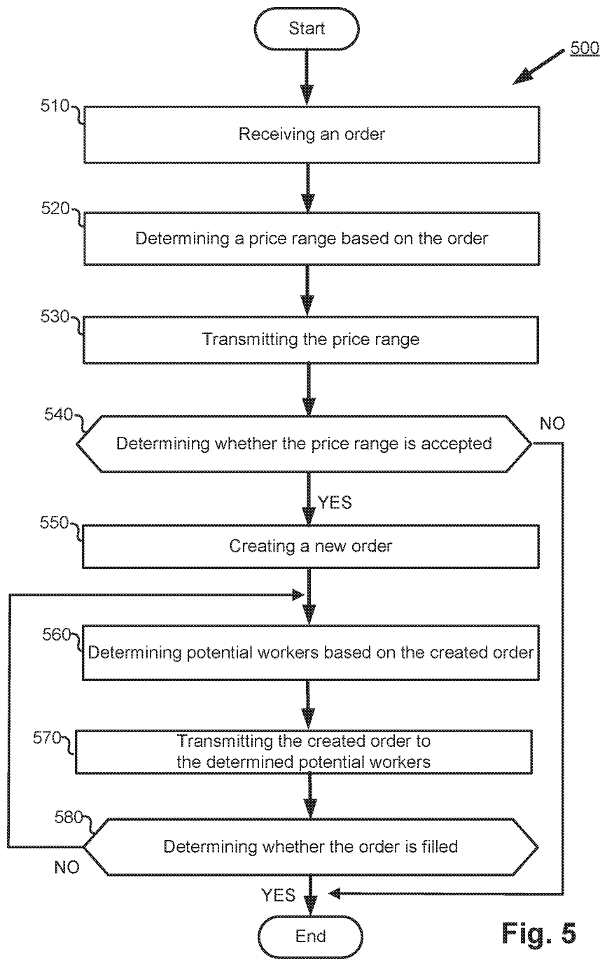

The data processing server 200 may be implemented in accordance with FIGS. 2A and 2B. The data processing server 200 also includes services as shown in FIG. 3. The operation of the data processing server 200 is described in relation to FIGS. 4 and 5.

The data processing server 200 is configured to maintain profiles of candidates/workers associated with staffing firms. As shown in FIG. 1, each staffing firm is associated with candidates and workers (as shown by the dotted lines). The data processing server 200 then aggregates the candidates/workers for the various staffing firms and adds, updates, enhances, and curates each of the candidate/worker profile.

The data processing server 200 is also configured to receive orders from customers and match the received orders with the candidates/workers stored in the data processing server 200.

The processes performed by the data processing server 200 will be described further in relation to FIGS. 3 to 5.

In the illustrative embodiment, the data processing server 200 provides an interface to enable communication with each of the customer computing devices 20A to 20N, the staffing firm computing devices 12A to 12N, the worker computing devices 14A-1 to 14A-N, 14N-1 to 14N-N, and the candidate computing devices 16A-1 to 16A-N, 16N-1 to 16N-N. The data processing server 200 provides an application programming interface (“API”) to facilitate such communication. Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

The customer computing devices 20A to 20N belongs to (e.g., own, use, etc.) respective entities 10A to 10N. Examples of the entities 10A to 10N include, among others, a company, an individual, an organization, and the like. Each entity 10A to 10N may own more than one computing device, but FIG. 1 shows only one computing device 20A, 20N per entity 10A, 10N for simplicity sake. The customer computing devices 20A to 20N will be collectively referred to hereinafter as the customer computing device 20. The entity 10A to 10N will be collectively referred to hereinafter as the customer 10.

A staffing firm 30A is shown in FIG. 1 to own a staffing firm computing device 12A. The staffing firm 30A may own more than one computing device, but FIG. 1 shows only one computing device 12A per staffing firm for simplicity sake. The staffing firm computing device 12A includes a database storing the candidate/worker profiles associated with the staffing firm 30A.

Another staffing firm 30N is shown in FIG. 1 to own another staffing firm computing device 12N. Similarly, the other staffing firm 30N may own more than one computing device, but FIG. 1 shows only one computing device 12N per staffing firm for simplicity sake. The staffing firm computing device 12N includes a database storing the candidate/worker profiles associated with the staffing firm 30N.

A staffing firm 30A, . . . , 30N is a firm that provides candidates/workers to be placed for a job. A staffing firm 30A, . . . , 30N may also be a talent pool provider.

Each staffing firm 30A, 30N is associated with workers and candidates. Candidates are potential workers who are yet to perform any work based on a job placement by the staffing firm. Candidates may not have been vetted before being registered in the data processing server 200. Workers are people who have been vetted and registered in the data processing server 200. As depicted in FIG. 1, a staffing firm 30A is associated with the worker computing devices 14A-1 to 14A-N, which belong to the respective workers associated with the staffing firm 30A. Similarly, the staffing firm 30A is associated with the candidate computing devices 16A-1 to 16A-N, which belong to the respective candidates associated with the staffing firm 30A.

In FIG. 1, each worker computing device 14A-1, 14A-N is owned/used by a worker and each candidate computing device 16A-1, 16A-N is owned/used by a candidate. However, each candidate/worker may own/use more than one computing device, but FIG. 1 shows only one computing device per candidate/worker for simplicity sake.

Hereinafter, the staffing firms 30A to 30N will be collectively referred to as the staffing firms 30. The staffing firm computing devices 12A to 12N will be collectively referred to as the staffing computing devices 12. The worker computing devices 14A-1 to 14A-N and 14N-1 to 14N-N will be collectively referred to as the worker computing devices 14. The candidate computing devices 16A-1 to 16A-N and 16N-1 to 16N-N will be collectively referred to as the worker computing devices 16.

The communication between the computing devices 12, 14, and 16 of a staffing firm 30 with the data processing server 200 will be described further in relation to FIGS. 3 to 5.

The computing devices 12, 14, 16, and 20 are devices that are used by users (i.e., a customer 10, a worker, a candidate, a recruiter of a staffing firm 30) who are registered with the data processing server 200. Examples of the computing devices 12, 14, 16, and 20 are tablets, laptops, desktop computers, smartphones, and the like. The computing devices 12, 14, 16, and 20 respectively connect with the data processing server 200.

### Data Processing Server 200

FIGS. 2A and 2B depict a general-purpose computer system, upon which the data processing server 200 can be practiced.

As seen in FIG. 2A, the data processing server 200 includes: a computer module 201; input devices such as a keyboard 202, a mouse pointer device 203, a scanner 226, a camera 227, and a microphone 280; and output devices including a printer 215, a display device 214 and loudspeakers 217. An external Modulator-Demodulator (Modem) transceiver device 216 may be used by the computer module 201 for communicating to and from a communications network 220 via a connection 221. The communications network 220 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220.

The computer module 201 typically includes at least one processor unit 205, and a memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 201, for example within the interface 208. The computer module 201 also has a local network interface 211, which permits coupling of the data processing server 200 via a connection 223 to a local-area communications network 222, known as a Local Area Network (LAN). As illustrated in FIG. 2A, the local communications network 222 may also couple to the wide-area communications network 220 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

As depicted in FIG. 2A, the data processing server 200 communicates with the respective computing devices 20, 12, 14, and 16 via the wide-area communications network 220.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the data processing server 200.

The components 205 to 213 of the computer module 201 typically communicate via an interconnected bus 204. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparcstations, Apple Mac™ or like computer systems.

The method shown in FIGS. 4 and 5 and services shown in FIG. 3 may be implemented as one or more software application programs 233 executable within the data processing server 200. In particular, the steps of the method of FIGS. 4 and 5 and services shown in FIG. 3 are effected by instructions 231 (see FIG. 2B) in the software 233 that are carried out within the data processing server 200. The software instructions 231 may be formed as one or more code modules, each for performing one or more particular tasks. The software may also be divided into two separate parts, in which a first part and the corresponding code modules performs the methods of FIGS. 4 and 5 and services shown in FIG. 3 and a second part and the corresponding code modules manage the API and corresponding user interfaces between the first part and the user.

The software may be stored in a computer readable medium, including the storage devices described below, for example. The software is loaded into the data processing server 200 from the computer readable medium, and then executed by the data processing server 200. A computer readable medium having such software or computer program recorded on the computer readable medium is a computer program product. The use of the computer program product in the data processing server 200 preferably affects an advantageous apparatus for performing the methods of FIGS. 4 and 5 and services shown in FIG. 3.

The software 233 is typically stored in the HDD 210 or the memory 206. The software is loaded into the data processing server 200 from a computer readable medium, and executed by the data processing server 200. Thus, for example, the software 233 may be stored on an optically readable disk storage medium (e.g., CD-ROM) 225 that is read by the optical disk drive 212. A computer readable medium having such software or computer program recorded on it is a computer program product. The use of the computer program product in the data processing server 200 preferably affects an apparatus for performing the methods of FIGS. 4 and 5 and services shown in FIG. 3.

In some instances, the application programs 233 may be encoded on one or more CD-ROMs 225 and read via the corresponding drive 212, or alternatively may be read from the networks 220 or 222. Still further, the software can also be loaded into the data processing server 200 from other computer readable media. Computer readable storage media refers to any non-transitory tangible storage medium that provides recorded instructions and/or data to the data processing server 200 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software, application programs, instructions and/or data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more API of the data processing server 200 with associated graphical user interfaces (GUIs) to be rendered or otherwise represented upon the display 214. Through manipulation of typically the keyboard 202 and the mouse 203, a user of the data processing server 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 210 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface management, and generic user interface management.

The operating system 253 manages the memory 234 (209, 206) to ensure that each process or application running on the computer module 201 has sufficient memory in which to execute without colliding with memory allocated to another process. Furthermore, the different types of memory available in the data processing server 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the data processing server 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 222, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The disclosed arrangements (e.g., the methods of FIGS. 4 and 5 and services shown in FIG. 3) use input variables 254, which are stored in the memory 234 in corresponding memory locations 255, 256, 257. The disclosed arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

a fetch operation, which fetches or reads an instruction 231 from a memory location 228, 229, 230;

a decode operation in which the control unit 239 determines which instruction has been fetched; and

an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 4 and 5 and services shown in FIG. 3 is associated with one or more segments of the program 233 and is performed by the register section 244, 245, 247, the ALU 240, and the control unit 239 in the processor 205 working together to perform the fetch, decode, and execute cycles for every instruction in the instruction set for the noted segments of the program 233.

The method of FIGS. 4 and 5 and services shown in FIG. 3 may alternatively be implemented in dedicated hardware such as one or more integrated circuits performing the functions or sub functions of the disclosed methods and services.

Alternatively, the method of FIGS. 4 and 5 and services shown in FIG. 3 may be deployed using virtual service on shared servers in the cloud. In this circumstance, the individual services 310 to 318 illustrated in FIG. 3 can be implemented as individual micro-services communicating with each other using an event based architecture.

### Operations of the Data Processing Server 200

### Registration of Users to the Data Processing Server 200

Before a user (i.e., a customer 10, a recruiter of a staffing firm 30, a worker, a candidate) of any computing devices 12, 14, 16, and 20 can use the data processing server 200, the user must register with the data processing server 200. The user separately registers with the data processing server 200.

The registration process for a user is performed by the user through one of the computing devices 12, 14, 16, and 20. In one arrangement, the user downloads an app associated with the data processing server 200 to the computing devices 12, 14, 16, and 20. In another arrangement, the user accesses a website of the data processing server 200 on the computing devices 12, 14, 16, and 20. As described above in relation to FIGS. 2A and 2B, the API is part of the software application program 233. Once the user accesses the app or website on the computing devices 12, 14, 16, and 20, the user is able to interact with the data processing server 200 to register.

Details of the registration for a candidate/worker include, for example, name of the candidate/worker, candidate/worker location, skills, experience, credentials (e.g., certificates, licences, etc.), background checks, preferences, contact details, personal identifying data (e.g., race, date of birth, etc.) and the like.

Details of the registration for a customer include, for example, name of the customer, industry, customer entity details (e.g., a company number, an employer number, etc.), a payment account, customer location, typical job orders, requirements (e.g., skills, experience, credentials (e.g., certificates, licences, etc.), background checks) for the typical job orders, contact details, and the like. The payment account is a financial account that the customer can use to transmit fund from or to receive fund.

The payment account is a financial account that the customer 10 can use to transmit fund from or to receive fund.

### Services of the Data Processing Server 200

FIG. 3 shows services that the data processing server 200 provide. The services include an ordering service 310, an order matching service 312, staffing firm talent pool services 314A to 314N, an exchange talent pool profile service 316, and a notification service 318.

As described hereinbefore, the computing devices 12, 14, 16, and 20 communicate with the data processing server 200 via the communications network 220. FIG. 3 does not show the communications network 220 for simplicity sake.

The ordering service 310 communicates with the computing devices 20 to receive orders for job placements from the customers 10. When an order is received, the customer 10 provides requirements for the job. Examples of the requirements include, among others, skills, experience, credentials, background checks, drug test, location, and the like. The customer 10 may also set whether to manually select one or more workers to invite for the job or to automatically enable the data processing server 200 to invite one or more workers for the job.

In one arrangement, the ordering service 310 also communicates with the exchange talent pool profile service 316 to determine a price range associated with the received order. The price range is determined by searching the exchange talent pool profile service 316 for the rates of candidates/workers that match the job requirements. For example, the order service 310 receives a job with a skill, such as janitorial work, and then determines a price range for janitorial work based on the rates of matching candidates/workers that are capable of performing janitorial work. Matching in the context of determining price range are workers/candidates that match all the customer's requirements and the preferences of the candidates/workers.

The ordering service 310 then transmits the determined price range to the customer 10, who placed the order. The ordering service 310 then receives a response (approval or denial) of the price range from the customer 10. In one arrangement, the customer 10 may approve the price range with a criterion of a maximum or minimum price of the candidates/workers to be matched with the order or a specific price.

The ordering service 310 then creates a new order when the price range is approved by the customer 10. The ordering service 310 communicates with the order matching service 312 to transmit the new order.

The ordering service 310 communicates with the order matching service 312 to receive any suggested changes to the order from the order matching service 312. In turn, the ordering service 310 transmits any suggested changes to the computing device 20 of the customer 10. If the order is changed by the customer 10, then the ordering service 310 sends the changed order to the order matching service 312.

In one alternative arrangement, the ordering service 310 communicates with the order matching service 312 to determine the market depth (e.g., number of potential workers, probability of filling the order, etc.) based on the requirements of the order. Then, in real time, the order matching service 312 determines the market depth and present the market depth, via the order service 310, to the computing device 20 of the customer 10. This alternative arrangement enables the customer 10 to modify an order in real time based on the presented market depth.

The order matching service 312 receives the new order from the ordering service 310 and determines candidate/worker profiles (stored in the exchange talent pool profile service 316) that match the new order created by the ordering service 310. The order matching service 312 communicates with the exchange talent pool profile service 316 to perform the matching. The matching of candidates/workers is based on the job requirements and the candidates/workers preferences.

In one arrangement, the order matching service 312 determines the candidate/worker profiles by determining various probabilities, such as a probability that the order is dispatched, a probability that the dispatched order is worked, a probability that the worked order is performed well, and the like. The order matching service 312 together with the exchange talent pool service 316 may provide such determination as market depth to the ordering service 310.

The order matching service 312 transmits the candidate/worker profiles, which are matched to the order, to the notification service 318. In one arrangement, the number of matched candidate/worker profiles may be set by the customer 10 when placing the order. In another arrangement, the data processing server 200 has a default number (e.g., 10, 20, etc.) of candidate/worker profiles that are to be matched to an order.

The transmission service 318 then determines whether the customer 10 wants to select one or more workers to invite for the job or to automatically enable the data processing server 200 to select one or more workers to invite. This process is described further in relation to step 570 of method 500 (see FIG. 5 below). The transmission service 318 then communicates with the computing devices 12, 14, 16, and 20 accordingly to notify the relevant users of the invitations. The transmission service 318 may provide the notification in the form of an SMS, a display on an app, an email, and the like. The transmission service 318 also communicates with the exchange talent pool profile service 316 to update the candidate/worker profile as to whether any invited candidate/worker accepts or rejects the invitation.

The staffing firm talent pool services 314A to 314N communicate with the computing devices 12, 14, 16 associated with the respective staffing firms 30. In other words, each staffing talent pool service 314A, . . . , 314N communicates with the computing devices 12, 14, 16 associated with one staffing firm 30. Each staffing talent pool service 314A, . . . , 314N also provides an API for that particular staffing firm 30 such that computing devices 12, 14, and 16 associated with the staffing firm 30 may see the branding of the staffing firm 30 when accessing the data processing server 200.

The staffing firm talent pool services 314A to 314N communicates with the respective staffing firm computing devices 12. The staffing firm computing device 12 includes a database of the candidates/workers profiles associated with that particular staffing firm 30. The staffing firm computing device 12 may then partially or fully upload the candidate/worker profiles in the database of the device 12 to the staffing firm talent pool service 314A, . . . , 314N.

The staffing firm talent pool services 314A to 314N also provide communication back to the staffing firm computing devices 12. Such communication may include, among others, candidates/workers of the staffing firm 30 (associated with that computing device 12) who have accepted jobs and/or hours worked by the candidates/workers.

Therefore, each staffing talent pool service 314A, . . . , 314N stores the candidate/worker profiles associated with one staffing firm 30.

The staffing firm talent pool services 314A to 314N communicate with the exchange talent pool profile service 316. The exchange talent pool profile service 316 receives the candidate/worker profiles from all the staffing firm talent pool services 314A to 314N and adds, updates, enhances, and curates the candidate/worker profiles.

The exchange talent pool profile service 316 stores each candidate/worker profile in two parts. The first part relates to information provided by the candidate/worker to the staffing firm talent pool service 314A, . . . , 314N. The second part relates to information (e.g., worker-related parameters) derived by the exchange talent pool profile service 316 from the candidate/worker behaviour when using the data processing server 200. The second part also relates to the enhanced/extended candidate/worker profile.

The exchange talent pool profile service 316 stores the following information on each candidate/worker profile:
1. Registration details (as described above in the registration section);
2. The staffing firm 30 from which the candidate/worker profile come and a time stamp;
3. Other staffing firms 30 that the candidate/worker is also associated with and respective time stamps;
4. Candidate/worker preferences;
5. System learned candidate/worker preferences;
6. Candidate/worker interaction with the data processing server 200 (e.g., dwell time, number of visits per 24 hour period);
7. Jobs that the candidate/worker accepts/rejects;
8. Characteristics of previously accepted jobs (e.g., customer profile, duration of job, etc.);
9. Ratings of previous jobs completed by the candidate/worker, where the ratings are submitted by the candidate/worker to the server 200;
10. Candidate/worker score that is based on any one of past reliability, level of engagement, performance rating, and any negative behaviours;
11. Behaviour of the candidate/worker; and
12. Performance ratings of the candidate/worker submitted by customers 10.

Item 1 can be systematically triggered to request candidates/workers for updated information based on existing information or fields added to the profile. The fields to be updated or added can be proposed based on other information that other similar candidates/workers have.

Items 2 and 3 are automatically captured at the time of registering or updating the candidate/worker profile.

Item 4: candidate/worker preferences relate to the preferences that the candidate/worker submits or responds to. Examples of preferences include, among others, preferred jobs, locations, travel distance, types of companies, nature of work characteristics (e.g., indoor, outdoor, team-based work, individual-based work, shift work, etc.), structure of work (e.g., independent contractor, on-demand, permanent, part-time, etc.) and the like. Item 4 can be systematically triggered to request candidates/workers for updated preferences.

Item 5: the service 316 derives the candidate/worker preferences based on item 4 and any behaviours of the candidate/worker (see item 11). For example, a candidate/worker may submit that he/she is willing to travel 10 miles for a job. However, when accepting job orders, the candidate/worker always accepts a job that is 5 miles or less. Therefore, the service 316 sets a system learned candidate/worker preference of 5 miles.

Item 6: these relate to how the candidate/worker interact with the server 200. For example, the dwell time is the amount of time the candidate/worker dwell on a job indicates the level of interest of the candidate/worker. The number of times a day that a candidate/worker opens an app of the server 200 indicates the level of engagement of the candidate/worker with the server 200.

Item 9: the ratings that the candidate/worker submit once the candidate/worker completes the job depend on the job type. For example, if the job is for shovelling snow, then ratings relating to the customer is not relevant. Examples of the ratings include, among others, job rating, customer rating, location rating, and the like.

Item 10: the candidate/worker score is a composite score taking into account positive and negative behaviours of the candidate/worker. Positive behaviours include successfully completing a certain number of jobs, showing up to jobs on time, and the like. Negative behaviours include failing to complete a certain number of jobs successfully, not showing up to jobs on time, and the like. The composite score may take into account, for example, items 9, 11, and 12.

Item 11: the behaviour of the worker includes how the candidate/worker browses the jobs being offered at the data processing server 200, whether the candidate/worker accepts or rejects an invitation to a job, the characteristics of the jobs accepted/rejected, and the like. Machine learning may be employed to learn the behaviour of the candidate/worker.

Item 12: the performance of the worker can be filled in via feedback from a customer 10 once the worker completes the job that the worker accepts. The performance may be quantified using a customer rating, reliability (e.g., attendance), number of hours worked, number of times they are invited by customers, attitude, and the like.

Items 1 and 4 belong to the first part of the candidate/worker profile, while items 2, 3, and 5 to 12 belong to the second part of the candidate/worker profile. The second part, as described above, is derived by the service 316. Item 1 is the only item received by the service 316 from the staffing firm computing device 12.

Items 6, 7, 8, 9, and 11 relate to actions of the workers (i.e., worker-related parameters) that are derived by the service 316.

Item 11 relate to input from the customers 10 (i.e., worker-related parameters) on the candidate/worker.

Items 5 and 10 relate to worker-related parameters that are determined based on the worker-related parameters (i.e., items 6, 7, 8, 9, and 11) and/or input from the customers 10 (i.e., item 11).

### A Method for Extending Profiles

FIG. 4 illustrates a flow diagram of a method 400 of extending and enhancing a candidate/worker profile in the exchange talent pool profile service 316. The method 400 may be implemented as one or more computer application programs 233, which are executable by the processor 205.

The method 400 commences at step 410 by receiving a candidate/worker profile. Such a profile is received when the exchange talent pool profile service 316 receives a profile from any one of the staffing firm talent pool services 314A to 314N. Simultaneously, the received profile is time stamped (i.e., time and date) (see item 2 above). The method 400 then proceeds from step 410 to step 420.

In step 420, the exchange talent pool profile service 316 detects whether there are any duplicates of the profile in any other staffing firm talent pool services 314A to 314N. For example, if the candidate/worker profile is received from a candidate/worker profile of staffing firm talent pool service 314A, then the exchange talent pool profile service 316 determines whether the created profile has any duplicate profiles in the other staffing firm talent pool services 314B to 314N.

If there are duplicate candidate/worker profiles, then all the duplicate profiles are stored and time stamped (see item 3 above). Priority is given to staffing firm 30 from which the candidate/worker profile is received at step 410.

The method 400 proceeds from step 420 to step 430.

In step 430, the exchange talent pool profile service 316 extends the profile by systematically triggering requests to candidates/workers for updated information based on existing information or fields added to the profile. As described before in relation to item 1, the service 316 determines any other fields that exist in similar candidate/worker profile and requests the candidate/worker to update the information on the added fields. The method 400 then proceeds from step 430 to step 440.

In step 440, the method 400 monitors the candidate/worker profile to determine whether any actions of the candidates/workers (e.g., see items 6, 7, 8, 9, 11) or input from the customer 10 (see item 12) relating to the profile have occurred. As described above, the actions or input may relate to the recorded behaviour of the candidate/worker or feedback from the customer 10.

If there is no action or input determined (NO), then the method 400 continues to monitor the candidate/worker profile. If there is an action or input determined (YES), the method 400 proceeds from step 440 to step 445.

In step 445, the method 400 derives worker-related parameters based on the determined actions or input. Step 445 will be described together with step 450 below. The method 400 proceeds from step 445 to step 450.

In step 450, the method 400 extends the candidate/worker profile based on the derived worker-related parameters. For example, if a candidate/worker rates multiple jobs that are similar with low ratings (e.g., 1 star out of 5), the service 316 derives the candidate/worker actions of performing such rating (step 445) and prompts the candidate/worker to update the preferences (item 4). The service 316 also extends the candidate/worker profile (step 450) by automatically updating the system learned preferences (item 5) and/or the composite score (item 10) to indicate that the candidate/worker does not prefer such jobs.

In another example, a candidate/worker rejects jobs with certain characteristics (which are listed as preferences in the profile), the service 316 derives the candidate/worker actions of rejecting such jobs that are indicated as preferred (step 445) and the candidate/worker is then prompted to update the preferences (which are specific to the rejected jobs) in the profile. The service 316 also extends the candidate/worker profile (step 450) by automatically updating the system learned preferences (item 5) and/or the composite score (item 10) to indicate that the candidate/worker does not prefer such jobs.

As shown in the example immediately above, the decision of the worker is collected automatically as the worker interacts with the jobs matched to them. All the parameters that influence the decision of whether to accept or reject a job are collected at the point of the decision being made (step 445). The collected parameters are then analysed to extend the candidate/worker profile (step 450).

In one arrangement, the analysis of the collected parameters is performed by inputting the collected parameters to a machine learning model such as gradient boosting, neural networks, random forest, and the like. The machine learning model is continuously trained and run against the collected parameters of the workers (i.e., the parameters of this worker and other workers) so that the machine learning model improves over time by learning from the actions of workers. The improvement to the machine learning model includes adjusting the weights applied to the inputs, assessment of new inputs, and the validity of existing inputs over time. In one arrangement, one predictor may be found to be less accurate than another and may be removed or replaced. The adjustment therefore takes into account the data available at the point in time the worker makes the decision, which then makes micro adjustments to the learned profile and in turn affects the matched jobs that are offered to the user. The micro adjustments also affect the machine learning model through the training process.

An example of the arrangement using the machine learning model is now discussed. When a worker receives matched jobs, there are three possible outcomes that are automatically collected for each matched job. The outcomes are:
1) acceptance—the worker accepts the matched job (e.g., by selecting a button to accept the job);
2) weak rejection—the worker reviews and does not accept the matched job, but does not remove the matched job; and
3) strong rejection—the worker reviews and rejects the matched job (e.g., by selecting a button to remove the matched job).

The outcome is then analysed against historical data of the worker. In the case of a lack of historical data, predictions are made about the worker based on similar workers (i.e., workers with similar characteristics).

In this example, the parameters collected and analysed by the machine learning model include, inter alia:
outcome of the worker receiving a matched job;
the characteristics of the matched job (such as pay rate, distance, shift start time, customer 10, etc.);
the characteristics of the worker (such as previous dispatch history, skills, job titles, job tickets, level of interaction with the platform historically, etc.);
Situational characteristics (such as time of day of making the decision, weather at the time of making the decision, traffic reports, other matched jobs on offer, time of year, etc.).

Once the parameters are analysed, the worker profile is extended based on the analysis. The machine learning model is also updated based on the analysis. This ensures the matching of jobs to workers is being adjusted to best suit the worker's characteristics and the situation of the job being matched to the worker.

In yet another example, when a candidate/worker provides low ratings to a particular type of industry or customer, the service 316 derives the candidate/worker actions (step 445) and extends the candidate/worker profile (step 450) by automatically updating the system learned preferences (item 5) and/or the composite score (item 10) to indicate that the candidate/worker does not prefer such jobs. The service 316 also removes that particular type of industry or customer from the matching algorithm. In other words, the candidate/worker is not invited to fill a job order for that particular type of industry or customer.

The method 400 then proceeds from step 450 to step 440 to continue monitoring the candidate/worker profile.

In the general case, the method 400 determines (step 440) actions of a user associated with a profile. The method then derives parameters of the user based on the determined actions (step 445) and extends the profile based on the derived parameters (step 450). The method 400 also determines input of a second user on the user associated with the profile (step 440), derives parameters of the user based on the determined input (step 445), and extends the profile based on the parameters derived based on the determined input (step 450).

### A Method of Creating a New Order

FIG. 5 is a flow diagram of a method 500 for processing a transaction (e.g., an order for a job placement). The method 500 is described in relation to an order for a job placement. The method 500 may be implemented as one or more computer application programs 233, which are executable by the processor 205.

The method 500 commences at step 510 where the ordering service 310 receives an order from a customer computing device 20 of a customer 10. As described above, the customer 10 provides the requirements for the job to the ordering service 310. The method 500 then proceeds from step 510 to step 520.

In step 520, the ordering service 310 communicates with the exchange talent pool profile service 316 to determine a price range for the order. As described above, the price range is determined by searching the exchange talent pool profile service 316 for the rates of candidates/workers that match the job requirements. The method 500 then proceeds from step 520 to step 530.

In step 530, the ordering service 310 transmits the determined price range to the computing device 20 of the customer 10 (who placed the order of step 510). The method 500 proceeds from step 530 to step 540.

In step 540, the ordering service 310 determines whether the price range is accepted, modified, or rejected. The ordering service 310 receives a response (accepting, modifying, or rejecting the price range) from the computing device 20 of the customer 10. If the response accepts or modifies the price range (YES), the method 500 proceeds from step 540 to step 550. Otherwise (NO), the method 500 concludes.

In step 550, the ordering service 310 creates a new order with the requirements of the customer 10.

In one alternative arrangement, the customer 10 enters the price range for the order (which is received at step 510) and steps 520 to 540 can be skipped.

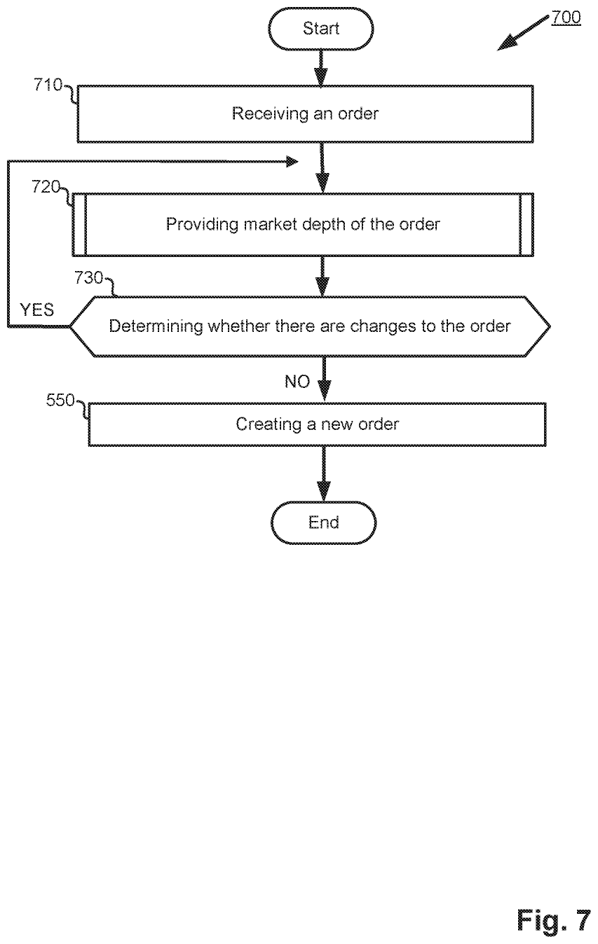

In another alternative arrangement, real time market depth (e.g., available potential workers, probability of depth, etc.) is shown to the customer 10 as the customer 10 is setting the requirements for an order. In this alternative arrangement, steps 520 to 540 can be skipped. The real time market depth arrangement is discussed below in relation to FIG. 7.

The method 500 proceeds from step 550 to step 560.

In step 560, the order matching service 312 determines potential workers based on the created order. The order matching service 312 communicates with the exchange talent pool profile service 316 to determine the candidate/worker profiles that would best match the order. For example, a worker may have a profile that matches the order. However, the worker profile indicates that the worker typically rejects a job that is more than 5 miles from the worker's location, while the order indicates that the job is 7 miles from the worker's location. In this example, the order matching service 312 determines that the likelihood of the worker accepting the offer is very low and determines that the worker does not match the order due to the worker's behaviour of rejecting orders beyond 5 miles of the worker's location.

In one arrangement, step 560 performs method 600 for determining potential workers. The method 600 is described below.

The method 500 proceeds from step 560 to step 570.

In step 570, the transmission service 318 transmits notification (e.g., an SMS, an email, a display on an app) to the workers identified to be suitable for the order. In one arrangement, the customer 10 indicates that the workers to be invited to the job are to be manually selected. In this arrangement, the notification service 318 transmits the notification to the computing device 20 of the customer 10. The customer 10 then selects on the computing device 20 the workers to be invited to the job. The transmission service 318 in turn receives the selection of workers from the computing device 20. The transmission service 318 then notifies the workers that they have been invited to the job. Simultaneously, the transmission service 318 notifies the exchange talent pool profile service 316 of the workers that have been invited so that the relevant worker profiles can be updated.

In another arrangement, the transmission service 318 transmits notifications to the candidate or worker computing device 14, 16 of the workers to be invited for the order. For example, the data processing server 200 has a default of determining 15 of the best matched candidate/worker profiles for an order. The transmission service 318 then transmits the notification to the 15 best matched workers to invite them to the job. Simultaneously, the transmission service 318 notifies the exchange talent pool profile service 316 of the workers that have been invited so that the relevant worker profiles can be updated.

The method 500 proceeds from step 570 to step 580.

In step 580, the notification service 318 determines whether the order is filled. In other words, the transmission service 318 determines whether any of the workers invited has accepted the invitation. If the order is not filled due to all the workers rejecting the invitation (NO), then the method 500 proceeds from step 580 to step 560 to find more workers to invite. If the order is filled (YES), the transmission service 318 sends further notification to the remaining workers that the order has been filled and the method 500 concludes. Simultaneously, the transmission service 318 notifies the exchange talent pool profile service 316 of the workers that have accepted the invitation and of the workers that have rejected the invitation so that the relevant worker profiles can be updated. The transmission service 318 also informs the computing device 12 of the staffing firm 30 of the job being filled by a worker and the price of the order.

Once the worker has attended and completed the job, the customer 10 can provide feedback to the exchange talent pool profile service 316 so that the worker profile can be updated. On the other hand, if the worker does not turn up to the job despite accepting the job, the customer 10 can also provide feedback (see item 12) to the exchange talent pool profile service 316 so that the worker profile can be updated.

### A Method of Determining Potential Workers

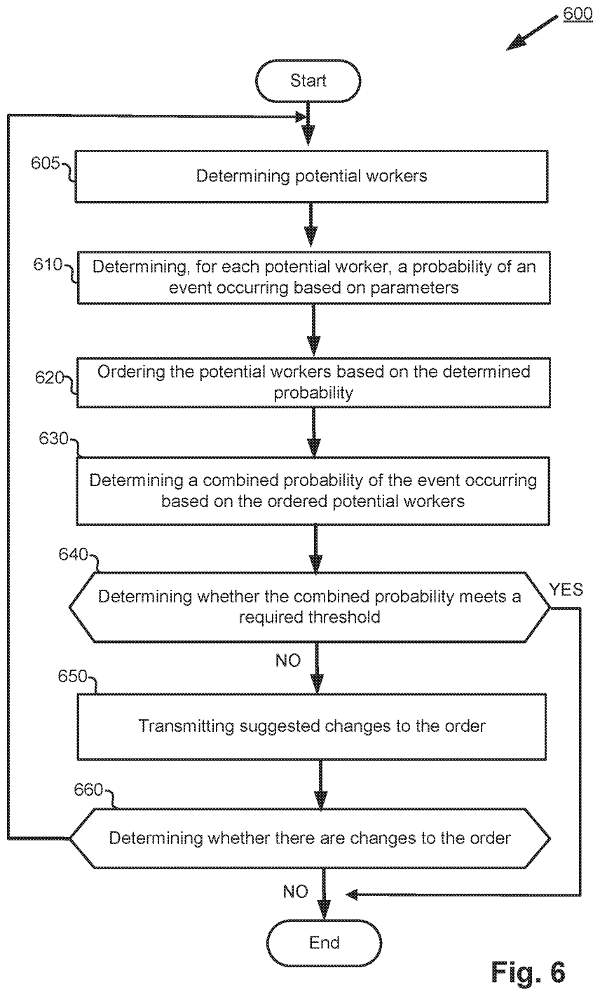

FIG. 6 is a flow diagram of a method 600 of determining potential workers. The method 600 may be implemented as one or more computer application programs 233, which are executable by the processor 205. As described above in step 560, the method 600 can be invoked by step 560 of the method 500. The method 600 is performed by the order matching service 312.

The method 600 relates to a matching process that uses a complex multi-dimensional matching method. In particular, the matching process uses probabilities of an order being dispatched and a dispatched order being worked to determine potential workers/candidates. The matching process also enables automation of the matching process that improves efficiency and effectiveness of the matching between on-demand job orders and workers/candidates.

The method 600 commences at step 605 by determining potential workers for an order. The order matching service 312 determines potential workers based on the created order. The order matching service 312 communicates with the exchange talent pool profile service 316 to determine the candidate/worker profiles that would best match the order. Initially, the determined candidates/workers can be any candidates/workers that match one or more of the order requirements. Other initial matching methods may be used.

If step 605 occurs after step 660, the determined candidates/workers determined at step 620 may be used.

The method 600 proceeds from step 605 to step 610.

Step 610 determines, for each potential candidate/worker, an event occurring based on parameters.

In one arrangement, step 610 determines a probability of an event of an order occurring based on parameters. An order lifecycle includes events such as receiving an order, matching candidates/workers to the order, transmitting notifications to the matched candidates/workers, receiving an acceptance of the job from one of the matched candidates/workers, receiving potential cancellation of the acceptance of the job, the candidate/worker accepting the job performing the job, and completing the job. There may be other events in the order lifecycle.

Therefore, step 610 determines, for example, a probability of an event (e.g., receiving an acceptance of the job from one of the matched candidates/workers) of an order occurring based on parameters (e.g., time between receiving an order and the start time of the job). Such determination of a probability may occur at another event (e.g., receiving an order) of the order. More than one such probability can be calculated in step 610.

At different events of the order lifecycle, there are different priorities to be met and different relevant parameters. For example, at the time of receiving an order, one of the priorities is to ensure the best worker for the job accepts the order. However, this is not a priority at the event of a worker performing the job or completing the job, as that worker already accepted the order. Therefore, the parameters are weighted differently to change the priority level at different events. In the above example, the parameter of worker skills is weighted highly at the event of “receiving an order.” However, the parameter of worker skills is weighted to be zero at the event of “working an order”.

The order of priorities at an event of the order lifecycle may also change. For example, if an order is received one week away from the start date of the job, then the highest priority may be to ensure the best skilled worker to accept the order. However, if an order is received one hour before the start time of the job, then the highest priority may be to ensure a worker (who is capable of performing the job, not necessarily the most skilled) accepts the order. Therefore, the parameters may also be weighted differently to change the priority level at an event.

In one arrangement, step 610 calculates (1) a probability that an order is dispatched and (2) a probability that a job is worked. The probability that an order is dispatched will be called the dispatched probability and the probability that a job is worked will be called the worked probability. The dispatched probability relates to the probability that the event of “receiving an acceptance of the job from one of the matched candidates/workers” occurs. The worked probability relates to the probability that the event of “completing the job” occurs. In this arrangement, the second event occurs at the first event of “receiving an order.”

Other probabilities of different events of an order occurring may also be calculated. The above two probabilities being calculated are only examples for describing the multi-dimensional matching method.

The parameters can be broadly categorized into four categories, as follows:
Job category—parameters relating to the requirements of an order as entered by the customer 10.
Supply category—parameters relating to available candidates/workers.
Worker category—parameters relating to an individual worker.
Situational category—parameters relating to the current state of the demand and supply in the server 200 when calculating the probabilities. The parameters in the situational category account for the environment within which the order and worker matching is being made.

Parameters that can be used in calculating the dispatched probability and the worked probability are as follows:
Time between receiving an order and the start time of the job in the order—used by both the dispatched probability and the worked probability. This parameter is in the situational category.
Time between acceptance of an order and the start time of the job in the order—used by the worked probability. This parameter is in the situational & supply categories.
Time of day of receiving an order—used by the dispatched probability. This parameter is in the situational category.
Pay rate of the job in the order (compared to local market)—used by both the dispatched probability and the worked probability. This parameter is in the situational category.
Number of available candidates/workers matching the order requirements—used by the dispatched probability. This parameter is in the supply category.
Distance preference of the available candidates/workers matching the order requirements—used by both the dispatched probability and the worked probability. This parameter is in the supply category.
Number of workers who have taken a job—used by the dispatched probability. This parameter is in the supply category.
Number of workers who have completed a job—used by the worked probability. This parameter is in the supply category.
Mean customer ratings by workers—used by both the dispatched probability and the worked probability. This parameter is in the job category.
Performance ratings of workers—used by both the dispatched probability and the worked probability. This parameter is in the supply category.
Reliability of the available candidates/workers—used by the worked probability. This parameter is in the supply category.
Number of hours of an order—used by both the dispatched probability and the worked probability. This parameter is in the job category.
Job start time—used by both the dispatched probability and the worked probability. This parameter is in the job category.
Day of week of the order—used by both the dispatched probability and the worked probability. This parameter is in the job category.
Worker Preferences. A pattern of dispatch decisions and completed jobs of a worker that is recorded by the Exchange Talent Pool Profile Service 316 (see the method 400 and attendant description above)—used by both the dispatched probability and the worked probability. This parameter is in the worker category.

Each of the dispatched probability and the worked probability is calculated using a linear regression method. Other methods can be used to calculate these probabilities.

In one arrangement, the following equation is used to calculate each the dispatched probability and the worked probability:

$$P = \frac{1}{1 + {e}^{- {\sum }_{j}^{n} {β}_{j} {X}_{j}}}$$

Where P is the probability value that an order is dispatched or worked (where the probability value can be between 0 and 1), Xⱼ is a parameter, βⱼ is equal to the coefficients (i.e., weighting) of the corresponding parameter, and n is equal to the number of parameters in the model.

For each order, after inserting the relevant set of parameters, the equation produces a value between 0 and 1. For the dispatched probability, the value represents the probability that an order will be dispatched. For the worked probability, the value represents the probability that an order will be worked.

In one example, there are two parameters to be used in calculating a probability. The above probability equation can be simplified to:

$$P = \frac{1}{1 + {e}^{- ( {β}_{0} {X}_{0} + {β}_{1} {X}_{1} + {β}_{2} {X}_{2} )}}$$

Where X₀ is set to 1, β₀ is a coefficient (i.e., weighting) to calculate the probability when all other parameters are equal to 0, X₁ is a first parameter, β₁ is equal to the coefficients (i.e., weighting) of the first parameter, X₂ is a second parameter, β₂ is equal to the coefficients (i.e., weighting) of the second parameter.

In one example, the dispatched probability is calculated using 3 parameters, as follows:
Pay rate of the job in the order (P)
Number of available candidates/workers matching the order requirements (N)
Mean customer ratings by workers (R)

The dispatched probability equation then becomes:

$$Dispatched Probability = \frac{1}{1 + {e}^{- ( {β}_{0} {X}_{0} + {β}_{P} P + {β}_{N} N + {β}_{R} R )}}$$

In this example, β_{P} is 0.003, β_{N} is 0.006, and β_{R} is 0.0003. These coefficients (i.e., weighting) can be obtained empirically. In this example, β₀ is set to −1.39. β₀ is calculated empirically.

In this example, 3 orders from 3 respective customers 10 are received. The customers 10 are Joe, Rachel and Trevor.

The parameters relating to Joe's order include: a pay rate (P) of $10,100 matching candidates/workers (N), and Joe's mean rating given by previous workers (R) is 3.5. Entering these parameters into the dispatched probability example equation gives a probability of 31% for a worker to accept the job. In other words, the probability of Joe's order being dispatched for a worker is 31%.

The parameters relating to Rachel's order include: a pay rate (P) of $13,500 matching candidates/workers (N), and Rachel's mean rating given by previous workers (R) is 4.5. Entering these parameters into the dispatched probability example equation gives a probability of 84% for a worker to accept the job. In other words, the probability of Rachel's order being dispatched for a worker is 84%.

The parameters relating to Trevor's order include: a pay rate (P) of $16,1500 matching candidates/workers (N), and Trevor's mean rating given by previous workers (R) is 5. Entering these parameters into the dispatched probability example equation gives a probability of 100% for a worker to accept a job. In other words, the probability of Trevor's order being dispatched for a worker is 100%.

The worked probability can be calculated in a similar manner as described above. Other probabilities may similarly be calculated in a similar manner as described above.

The different parameters used in calculating the probabilities enable different factors to be taken into account. For example, using the parameter of “worker ratings” in calculating the worked probability allows the worked probability to also determine the expected quality of work of a particular worker.

The method 600 then proceeds from step 610 to step 620.

Step 620 orders the potential workers based on the determined probability. In this arrangement, two probabilities (the dispatched probability and the worked probability) are calculated in step 610 and are used in ordering the potential workers.

The probability (or probabilities) calculated in step 610 are then input into a weighted equation to obtain a stack rank score of a particular worker. The stack rank scores of the workers are used to order the workers determined at step 605. The weighted equation is as follows:

$$s = {\sum }_{i}^{n} {x}_{i} {P}_{i}$$

Where s is the stack rank score, Pᵢ is a probability calculated at step 610, and xᵢ is the weight assigned to the probability.

The dispatched probability and the worked probability are then used in combination to stack rank demand (i.e., orders) against supply (i.e., available workers). The stack ranking is adjusted as the supply changes. For example, if a worker that is determined to be available takes another order, then that worker is removed from the ordering.

In one example, job A and job B are received and worker A and worker B have been determined initially at step 605 to meet the requirements of both jobs A and B. The dispatched probability and the worked probability are then calculated and the results are as follows:

| | Job A | Job B |
|---|---|---|
| Worker A | Dispatched probability = 80% | Dispatched probability = 80% |
| | Worked probability = 40% | Worked probability = 60% |
| Worker B | Dispatched probability = 70% | Dispatched probability = 80% |
| | Worked probability = 70% | Worked probability = 30% |

The dispatched probability and the worked probability are input into a weighted equation to compute the stack ranking for each worker. The weighting can be set based on the importance of the event. The weighted equation is as follows:

s=x₁P_{D}+x₂P_{W}

Where s is the stack rank score, P_{D} is the dispatched probability, x₁ is the weight for the dispatched probability, P_{W} is the worked probability, and x₂ is the weight for the worked probability.

The results of the stack ranking are as follows:

| Worker A | Worker B |
|---|---|
| Job B | Job A |
| Job A | Job B |

In this example, worker A would be shown job B over job A as worker A has a higher stack rank score for job B than worker B. Similarly, worker B would be shown job A over job B due to the stack rank scores of the respective workers. Therefore, at the conclusion of step 620, each order has a list of ordered workers based on the probabilities calculated for each worker.

In one optional arrangement, step 620 performs a filtering process to remove certain workers from an order. For example, the order requires 100 potential workers to be offered the order. To meet this requirement, after ordering the potential workers, any workers beyond 100 are removed.

The method 600 proceeds from step 620 to step 630.

In step 630, the method 600 determines a combined probability of the event based on the determined potential workers.

For example, a combined probability of an event occurring based on the ordered potential workers is calculated.

The combined probability may be a calculation of the mean of each probability calculated at step 610 or the mean of all the probabilities calculated at step 610.

For example, the combined probability is the mean of all the dispatched probabilities of the ordered workers, and the mean of all the worked probabilities of the ordered workers. The combined probability in this example is provided as two different probability values relating to two different items.

In one arrangement, the combined probability is a combination of the mean of the combined dispatched probability and the combined worked probability. In this example, the combined probability is the mean all the probabilities calculated at step 610.

The combined probability value(s) can be provided to the different services (e.g., 316) to enable the different services to perform different actions. For example, if the service 316 receives a combined dispatched probability of 30%, the service 316 may prompt a user that more workers are required. On the other hand, if the service 312 receives a combined dispatched probability of 30%, the service 312 may prompt the customer 10 to change the order (as discussed in step 650 below).

In one arrangement, a service can perform automated decisions based on the combined probability value(s).

The method 600 proceeds from step 630 to step 640.

Step 640 determines whether the combined fill probability meets a required threshold. The combined fill probability may be any one of the combined dispatched probability, the combined worked probability, and the combined probability of all the probabilities. For example, the threshold can be a combined probability value of 50%. If the combined probability meets the required threshold (e.g., 50%) (YES), the method 600 concludes and the method 500 (which is the method invoking the method 600) continues at step 570. If the combined probability does not meet the required threshold (e.g., 50%) (NO), the method 600 proceeds from step 640 to step 650.

Step 650 transmits suggested changes to the order. The suggested changes are transmitted by the order matching service 312 to the ordering service 310, which in turn transmits the suggested changes to the computing device 20 of the customer 10.

For example, the order matching service 312 determines that the combined dispatched probability is 10% and that the combined dispatched probability can be increased if the pay rate of the order is increased. Accordingly, the suggested change may be to increase the pay rate of the order.

The method 600 proceeds from step 650 to step 660.

In step 660, the method 600 determines whether there are changes to the order. Any change in the order is received from the ordering service 310. If there is no change to the order (NO), the method 600 concludes and the method 500 (which is the method invoking the method 600) continues at step 570. If there is a change in the order (YES), the method 600 proceeds from step 660 to step 605 so that the probabilities of the changed order can be calculated.

Steps 640 to 660 are optional steps that can be skipped.

The method 600 enables real time supply and demand parameter adjustment. The probability values provide real time insight into the likelihood of an order obtaining a certain outcome (e.g., an order being dispatched or worked) in the order lifecycle. Therefore, calculating the probability values enables the order matching service 312 to determine parameters that are causing the probability values to be below or above a threshold value. Once these parameters are determined, parameters can be adjusted in real time in the most efficient manner to match demand requirements with supply requirements.

In one example, in one order, the distance of available workers for a job is initially set to 50 miles. The dispatched probabilities and worked probabilities are determined to be above a threshold (e.g., 75%). Therefore, the order matching service 312 may adjust the required distance (i.e., by reducing the required distance) as long as the combined probability (calculated at step 630) does not decrease below the threshold of 75%.

In another example, in orders requiring construction workers, the combined probability (calculated at step 630) is consistently below a threshold (e.g., 30%). The transmission service 318 may trigger a prompt to staffing firms 30 that more construction workers are required in order to meet demand.

### An Alternative Method of Creating a New Order

FIG. 7 is a flow diagram of a method 700 for processing a transaction (e.g., an order for a job placement). The method 700 is described in relation to an order for a job placement. The method 700 may be implemented as one or more computer application programs 233, which are executable by the processor 205. The method 700 is an alternative to the method 500.

The method 700 commences at step 710 where the ordering service 310 receives an order from a customer computing device 20 of a customer 10. As described above, the customer 10 provides the requirements for the job to the ordering service 310. The method 700 then proceeds from step 710 to sub-process 720.

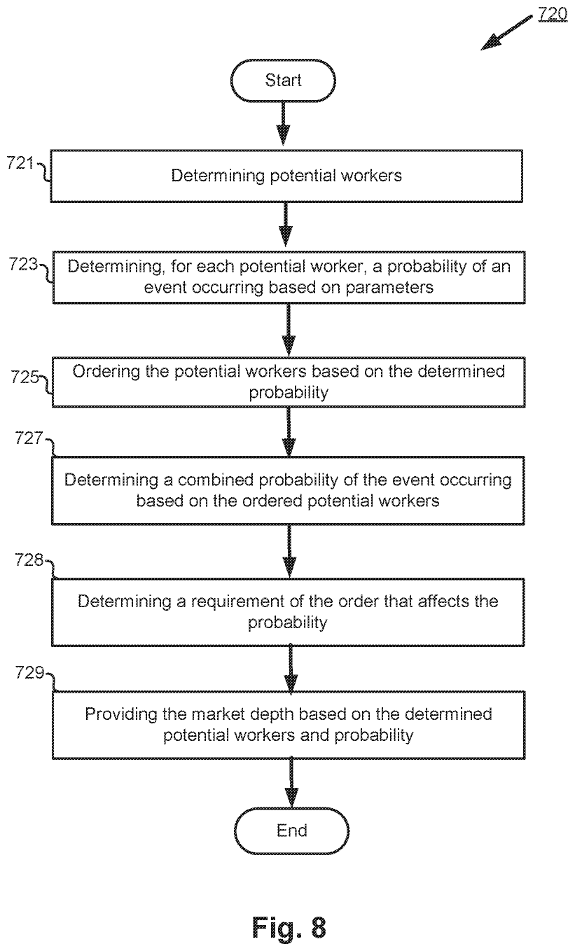

In sub-process 720, the market depth of the order received at step 710 is provided to the computing device 20 of the customer 10. Sub-process 720 is shown in FIG. 8. The determination of the market depth is performed by the order matching service 312 and the exchange talent pool service 316, while the transmission of the market depth to the computing device 20 is performed by the ordering service 310. Sub-process 720 commences at step 721 by determining potential workers for the order received at step 710. Step 721 is similar to step 605 of the method 600. Sub-process 720 then proceeds from step 721 to step 723.

In step 723, a probability of an event occurring based on parameters is determined. Step 723 is similar to step 610. Further, similar to step 610, more than one probability may be determined. Sub-process 720 proceeds from step 723 to step 725.

In step 725, the potential workers determined at step 721 are ordered based on the determined probability of step 723. Step 725 is similar to step 620. Sub-process 720 proceeds from step 725 to step 727.

In step 727, a combined probability of the event based on the ordered potential workers is determined. Step 727 is similar to step 630. Sub-process 720 proceeds from step 727 to step 728.

In step 728, the method 700 determines a requirement of the order that affects the probability (i.e., the probability determined at step 723 or step 727) adversely. For example, the method 700 determines that the price set for the order is too low based on the number of orders with similar requirements being filled at a similar price.

Other examples of requirements that may affect the probability of fill include:
a. The background checks required on the order
b. The drug tests which are required on the order
c. The start time of the work
d. The day of the week that the work is requested

For example, there are many workers that could fill the order but could not meet the background checks requirement. The method 700 may then provide an indication that some workers are being excluded from the order due to this requirement.

Sub-process 720 proceeds from step 728 to step 729.

In step 729, the market depth based on the determined number of available potential workers and probability is provided. The exchange talent pool service 316 determines the market depth and provides the determined market depth to the computing device 20 via the order matching service 312 and the ordering service 310.

Sub-process 720 terminates at the conclusion of step 729. The method 700 then proceeds from sub-process 720 to step 730.

In step 730, the method 700 determines whether there are changes to the order. If there are changes (YES), the method 700 proceeds from step 730 to step 720 so that the market depth of the updated order can be shown. Otherwise (NO), the method 700 proceeds from step 730 to step 550.

In step 550, the method 700 creates a new order based on the order received from the computing device 20 of the customer 10. Although not shown in the method 700, the method 700 proceeds with steps 560 to 580 of the method 500. When performing method 700, step 560 may use the potential workers that are already determined by sub-process 720.

The method 700 therefore enables a customer 10 to view the market depth as the customer 10 is setting requirements for an order at a computing device 20. For example, the customer 10 sets a price for the order to be $10/hr and a rating to be 4 star and above. The market depth of this order is then presented as having 10% chance of being filled and the market depth also presents requirements that result in the probability of fill being low. The customer 10 may decide that such a probability is too low and change the order requirements accordingly. The market depth therefore provides a guidance to customers 10 on adjusting orders in real time and also to adjust the order based on the customers' needs.

### Invitation of Potential Workers

As described above in relating to the ordering service 310, the customer 10 may set whether to manually select one or more workers to invite for the job or to automatically enable the data processing server 200 to invite one or more workers for the job. If the customer 10 sets to manually select one or more workers to invite for the order, then the ordering service 310 presents potential workers that the customer 10 may invite for the order.

The function to invite potential workers may be performed after sub-process 720 of the method 700 or step 560 of the method 500. From the list of potential workers, the top workers are chosen and presented to the customer 10 to enable the customer 10 to invite any one of the presented top workers. The top workers may be categorized into: top workers who previously worked for the customer 10 and top workers who best matched the order. The best matched category may be met by a worker if a certain number of parameters (e.g., skills, performance ratings, location, etc.) of a worker closely match the order requirements.

The top workers may be determined with a threshold. An example of the threshold is the number of workers (e.g., the top 5, the top 10, and the like). The threshold may be decided by the provider of the data processing server 200.

The top workers in the category of best matched potential workers may be anonymized.

### INDUSTRIAL APPLICABILITY

The arrangements described are applicable to the computer and data processing industries.

The foregoing describes only some embodiments of the present invention, and modifications and/or changes can be made thereto without departing from the scope and spirit of the invention, the embodiments being illustrative and not restrictive.

1. A server comprising:
a processor;
a communication interface in communication with the processor, the communication interface being configured to communicate with computing devices to receive profiles stored on the computing devices;
memory in communication with the processor, wherein the memory comprises computer application programs that are executable by the processor to perform a method of extending one of the profiles, the method comprising:
receiving, by the server, the profiles from the computing devices;
determining actions of a user associated with one of the profiles;
deriving parameters of the user based on the determined actions; and
extending the profile of the user based on the derived parameters.

2. The server of claim 1, wherein the actions comprise accepting, weakly rejecting, or strongly rejecting a job matched to the profile;

3. The server of claim 1, wherein the method further comprises analysing the derived parameters using a machine learning model.

4. The server of claim 1, wherein the method further comprises:
determining input of a second user on the user associated with the profile;
deriving parameters of the user based on the determined input; and
extending the profile based on the parameters derived based on the determined input.

5. The server of claim 4, wherein the user is a candidate for a job or a worker for the job.

6. The server of claim 4, wherein the second user is a customer.

7. The server of claim 1, wherein the computing devices are associated with staffing firms.

8. The server of claim 1, wherein the method further comprises:
determining whether there is a duplicate profile for each of the received profiles; and
in response to determining there is a duplicate profile, time stamping and storing the duplicate profile.

9. A non-transitory computer readable medium comprising:
computer application programs that are executable by a processor, the computer application programs comprising a method of extending a profile, wherein the processor executes the computer application programs to perform the method, the method comprising:
receiving profiles from computing devices;
determining actions of a user associated with one of the profiles;
deriving parameters of the user based on the determined actions; and
extending the profile of the user based on the derived parameters.

10. The non-transitory computer readable medium of claim 9, wherein the actions comprise accepting, weakly rejecting, or strongly rejecting a job matched to the profile;

11. The non-transitory computer readable medium of claim 10, wherein the method further comprises analysing the derived parameters using a machine learning model.

12. The non-transitory computer readable medium of claim 9, wherein the method further comprises:
determining input of a second user on the user associated with the profile;
deriving parameters of the user based on the determined input; and
extending the profile based on the parameters derived based on the determined input.

13. The non-transitory computer readable medium of claim 12, wherein the user is a candidate for a job or a worker for the job.

14. The non-transitory computer readable medium of claim 12, wherein the second user is a customer.

15. The non-transitory computer readable medium of claim 9, wherein the computing devices are associated with staffing firms.

16. The non-transitory computer readable medium of claim 9, wherein the method further comprises:
determining whether there is a duplicate profile for each of the received profiles; and
in response to determining there is a duplicate profile, time stamping and storing the duplicate profile.
